(19) United States
(12) Patent Application Publication
(10) Pub. No.: US 2012/0200753 A1
(43) Pub. Date: Aug. 9, 2012

(54) SOLID-STATE IMAGE PICKUP DEVICE

(76) Inventors: Yasuyuki Endoh, Hyogo (JP); Takashi Fujioka, Kyoto (JP)

(21) Appl. No.: 13/500,591

(22) PCT Filed: Feb. 19, 2010
(86) PCT No.: PCT/JP2010/001074

§ 371 Date: Apr. 5, 2012

(30) Foreign Application Priority Data
Oct. 20, 2009 (JP) 2009-241342

(51) Int. Cl. H04N 5/335

(52) U.S. Cl. 348/301; 348/E05.091

(57) ABSTRACT

During the vertical blanking period, first the vertical common signal line switch transistor 213 is turned OFF, then the clamp transistor 218 is turned ON, thereby fixing the sample/hold capacitor 223 to the clamp potential. Also, the column amplifier reset transistor 217 is turned ON, and the column amplifier 216 is reset. Next, the column amplifier reset transistor 217 and the clamp transistor 218 are turned OFF, and the unit column circuit 105 is kept to the clamp state. In this state, the sample/hold transistor 221 is turned OFF, and the sample/hold capacitance 223 is read. The read data is used as the data for correcting the vertical fixed pattern noise.

### TECHNICAL FIELD

The present invention relates to a solid-state imaging apparatus of a MOS (Metal Oxide Semiconductor) type, and in particular to a technology for solving the problem of the fixed column pattern noise that appears like a vertical line.

### BACKGROUND ART

In a MOS-type solid-state imaging apparatus such as a CMOS image sensor, a unit column circuit is provided for each column of pixels cells that are arranged two-dimensionally, and the unit column circuits amplify and hold pixel signals. The property of the unit column circuit would vary primarily due to processing variation. This causes a fixed column pattern noise appearing like a vertical line. The noise is called “vertical fixed pattern noise” and is one of dominant noises that occur in the MOS-type solid-state imaging apparatuses.

As a method of reducing the effect of processing variation, increasing the pixel size, for example, might be considered. However, basically the unit column circuits need to be formed at the pixel pitch. On the other hand, the pixel size is subject to the restriction of the pixel pitch. Thus the method of increasing the pixel size cannot be used for the purpose of reducing the effect of processing variation to property of the unit column circuit.

It is accordingly typical in MOS-type solid-state imaging apparatuses to make a correction by removing a difference in property between the unit column circuits, in particular, by removing an offset component that does not depend on the level of the pixel signal. To improve the accuracy of the correction, it is important to extract an offset component between the unit column circuits with high accuracy.

FIG. 17 illustrates an example of the structure of a solid-state imaging apparatus in a conventional technology (Patent Literature 1). As shown in FIG. 17, according to the conventional technology, vertical common signal lines 1790 are connected to dummy pixel transistors 1721. This causes signals from dummy pixels, as well as signals from effective pixels, to be output to the unit column circuits.

That is to say, gate potentials of the dummy pixel transistors 1721 are set by a correction bias circuit 1723, and when a row of dummy pixel transistors 1721 is selected during sequential reading by a vertical drive, outputs from dummy pixel transistors 1721, whose gate potentials are fixed to a bias potential for correction, are read, and the outputs are used as the data for correcting the vertical fixed pattern noise.

There is also known a method in which, to obtain the data for correcting the vertical fixed pattern noise, dummy pixels are arranged in the same layout as the effective pixels, and with respect to only the dummy pixels, the gate potential of the source follower transistor is fixed to an appropriate bias voltage, and outputs from the dummy pixels are read and used as the data for correcting the vertical fixed pattern noise.

Furthermore, there is used a method for obtaining the data for correcting the vertical fixed pattern noise by performing a control that is different from a control performed on a part of the effective pixels, such as turning ON a reset transistor to keep a gate voltage of a source follower transistor to a reset potential.

### CITATION LIST

### Patent Literature

### [Patent Literature 1]

Japanese Patent Application Publication No. 2008-124527

### SUMMARY OF INVENTION

### Technical Problem

In the conventional technologies, to correct the vertical fixed pattern noise with accuracy, the sizes of the dummy pixel transistors 1721 and dummy pixel selection transistors 1722 need to be equal to or larger than the sizes of the corresponding transistors for the effective pixels. However, as with the unit column circuits, the dummy pixels need to be formed at the pixel pitch. Thus the method of increasing the size of the dummy pixel transistors 1721 and the like cannot be used.

In the case where dummy pixels having approximately the same size as the effective pixels are used, there is a method in which a lot of dummy pixels are provided and the outputs of the dummy pixels are added up, and an average of the sum is used to reduce the effect of processing variation to the dummy pixel transistors 1721 and dummy pixel selection transistors 1722. However, according to this method, to improve the correction accuracy, a lot of dummy pixels need to be provided. This requires a large layout area to be ensured, and this goes against the demand for the miniaturization of the solid-state imaging apparatus.

It is therefore an object of the present invention to provide a solid-state imaging apparatus that can correct the vertical fixed pattern noise with high accuracy without increase in size of the apparatus.

### Solution to Problem

The above object is fulfilled by a solid-state imaging apparatus of a MOS (Metal Oxide Semiconductor) type in which a plurality of pixel cells are arranged two-dimensionally in rows and columns, the solid-state imaging apparatus comprising: vertical common signal lines each connected to pixel cells in a different column; unit column circuits connected to the vertical common signal lines on a one-to-one basis, and each including an amplifier and a capacitor, the amplifier amplifying pixel signals input from pixel cells in a column via a corresponding vertical common signal line, and the capacitor holding the pixel signals amplified by the amplifier; switches each provided between a vertical common signal line and a unit column circuit, and enabling and disabling an electrical connection between the vertical common signal line and the unit column circuit; and a reading unit resetting each capacitor and reading outputs from the unit column circuits while the electrical connection is disabled and shut off by each switch.

### Advantageous Effects of Invention

With the above structure, only the switch is added, but there is no need to add dummy pixels. Accordingly, it is possible to obtain the data for correcting the vertical fixed pattern noise with accuracy, while restricting the increase of layout area.

The above-described solid-state imaging apparatus may further comprise: a reset unit resetting each capacitor by applying a predetermined voltage thereto. Also, the above-described solid-state imaging apparatus may further comprise: an input unit inputting a predetermined potential to each unit column circuit while the electrical connection is shut off by the switch. With the above structure, it is possible to stabilize the input potential to the unit column circuit, making it possible to obtain the correction data with more accuracy.

In the above-described solid-state imaging apparatus, the predetermined potential may be a ground potential. With this structure, it is possible to improve the accuracy of the data for correcting the vertical fixed pattern noise because a constant voltage source and a ground line have low impedance.

In the above-described solid-state imaging apparatus, the predetermined potential may be a potential of current received by a bonding pad that is not electrically connected to any line that is connected to another circuit in the apparatus. By using a dedicated bonding pad as in the above structure, it is possible to remove the effect of the other circuits in the solid-state imaging apparatus.

In the above-described solid-state imaging apparatus, the predetermined potential may be a potential supplied from a line that is, only at one end thereof, electrically connected to another line in the apparatus. With this structure, it is possible to prevent a shading from being generated in the input voltage of the unit column circuits in the horizontal direction, and prevent the accuracy of the data for correcting the vertical fixed pattern noise from being reduced.

The above-described solid-state imaging apparatus may further comprise: correction pixels which are read in a similar manner as the pixel cells; and correction pixel reading units provided in correspondence with the correction pixels, each correction pixel reading unit reading an output from a corresponding correction pixel when the reading unit reads the outputs from the unit column circuits. This structure eliminates a difference in the current change between reading of the effective pixels and obtaining the correction data during the operation of the solid-state imaging apparatus. This improves the accuracy of the correction data.

In the above-described solid-state imaging apparatus, each switch may enable and disable the electrical connection between the vertical common signal line and the unit column circuit in a vertical blanking period. This structure makes it possible to minimize the layout area required for obtaining the data for correcting the vertical fixed pattern noise. This enables the switch to be implemented by, for example, adding only one transistor. This is very effective for the miniaturization of the solid-state imaging apparatus.

### BRIEF DESCRIPTION OF DRAWINGS

FIG. 1 illustrates the main structure of the solid-state imaging apparatus in the first embodiment of the present invention.

FIG. 2 is a circuit diagram illustrating the structure of the solid-state imaging apparatus in the first embodiment of the present invention.

FIG. 3 is a timing chart illustrating the operation of the solid-state imaging apparatus in the first embodiment of the present invention.

FIG. 4 is a circuit diagram illustrating the structure of the solid-state imaging apparatus in the second embodiment of the present invention.

FIG. 5 is a circuit diagram illustrating the structure of the solid-state imaging apparatus in the third embodiment of the present invention.

FIG. 6 is a timing chart illustrating the operation of the solid-state imaging apparatus in the third embodiment of the present invention.

FIG. 7 is a circuit diagram illustrating the structure of the solid-state imaging apparatus in the fourth embodiment of the present invention.

FIG. 8 is a circuit diagram illustrating the structure of the solid-state imaging apparatus in the fifth embodiment of the present invention.

FIG. 9 is a circuit diagram illustrating the structure of the solid-state imaging apparatus in the sixth embodiment of the present invention.

FIG. 10 is a circuit diagram illustrating the structure of the solid-state imaging apparatus in the seventh embodiment of the present invention.

FIG. 11 is a timing chart illustrating the operation of the solid-state imaging apparatus in the seventh embodiment of the present invention.

FIG. 12 is a circuit diagram illustrating the structure of the solid-state imaging apparatus in the eighth embodiment of the present invention.

FIG. 13 is a timing chart illustrating the operation of the solid-state imaging apparatus in the eighth embodiment of the present invention.

FIG. 14 is a circuit diagram illustrating the structure of the solid-state imaging apparatus in the ninth embodiment of the present invention.

FIG. 15 is a timing chart illustrating the operation of the solid-state imaging apparatus in the ninth embodiment of the present invention.

FIG. 16 is a circuit diagram illustrating the structure of the solid-state imaging apparatus in the tenth embodiment of the present invention.

FIG. 17 is a diagram illustrating the structure of a solid-state imaging apparatus of a conventional technology.

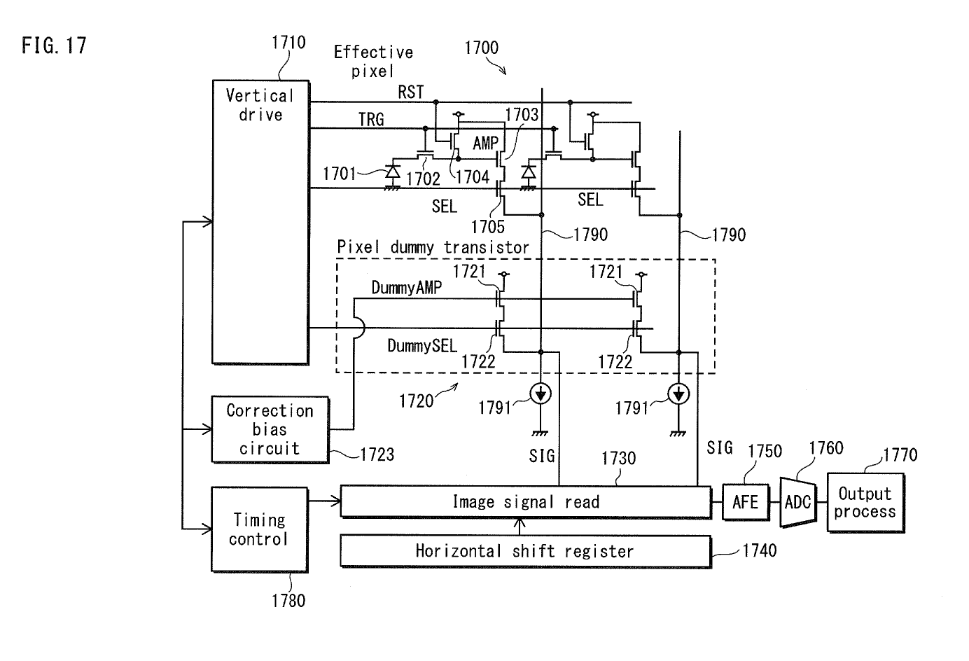

### DESCRIPTION OF EMBODIMENTS

Embodiments of the present invention of a solid-state imaging apparatus are described below with reference to the attached drawings.

### [1] First Embodiment

The following describes a solid-state imaging apparatus of the first embodiment of the present invention. The solid-state imaging apparatus of the present embodiment is characterized by a means for shutting off signals that are to be input from the vertical common signal lines to the unit column circuits. In this shut-off state, data for correcting the vertical fixed pattern noise is obtained.

### (1-1) Structure of Solid-State Imaging Apparatus

First the structure of the solid-state imaging apparatus in the present embodiment is explained.

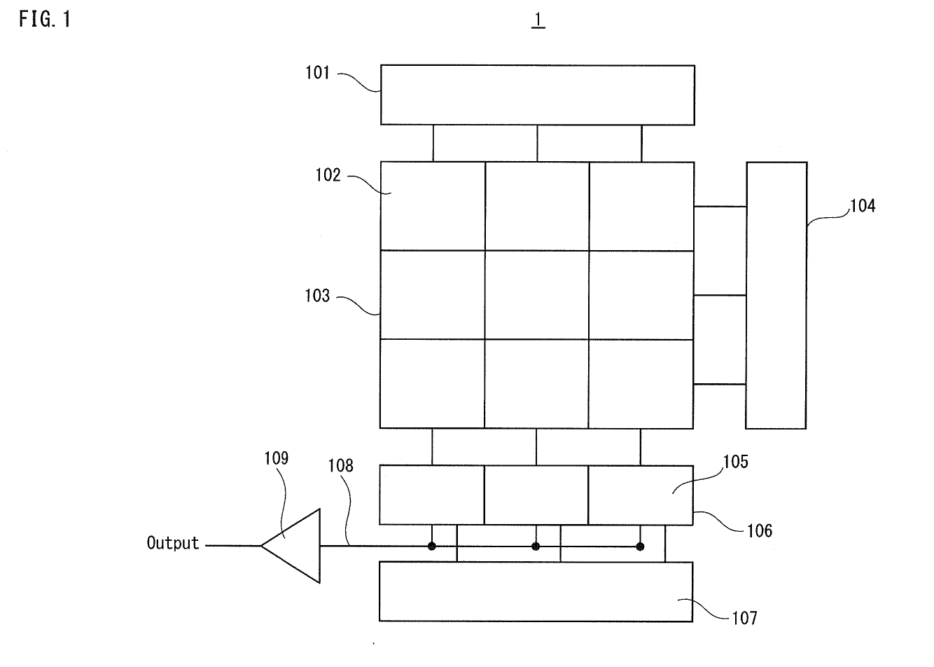

FIG. 1 illustrates the main structure of the solid-state imaging apparatus in the present embodiment. As shown in FIG. 1, a solid-state imaging apparatus 1 includes a current source circuit block 101, a pixel array 103, a vertical scanning circuit 104, a column circuit block 106, a horizontal scanning circuit 107, a horizontal common signal line 108, and an output amplifier 109.

A multiplicity of pixel cells 102 are two-dimensionally arranged in the pixel array 103. The current source circuit block 101 supplies constant current to a source follower transistor that is provided in each of the pixel cells 102. The column circuit block 106 is composed of unit column circuits 105 arranged in the horizontal direction, wherein the unit column circuits 105 in the column circuit block 106 come from respective columns of unit column circuits 105 in the pixel array 103.

The column circuit block 106 is composed of a plurality of unit column circuits 105 arranged in the horizontal direction. Pixel signals of pixel cells in a row selected by the vertical scanning circuit 104 are transferred to the column circuit block 106, and the pixel signals are processed in parallel by the respectively corresponding unit column circuits 105 in the column circuit block 106, and then held by the unit column circuits 105. The pixel signals held by the unit column circuits 105 are selected by the horizontal scanning circuit 107 one by one, transferred through the horizontal common signal line 108, amplified by the output amplifier 109, and then output to outside of the solid-state imaging apparatus 1.

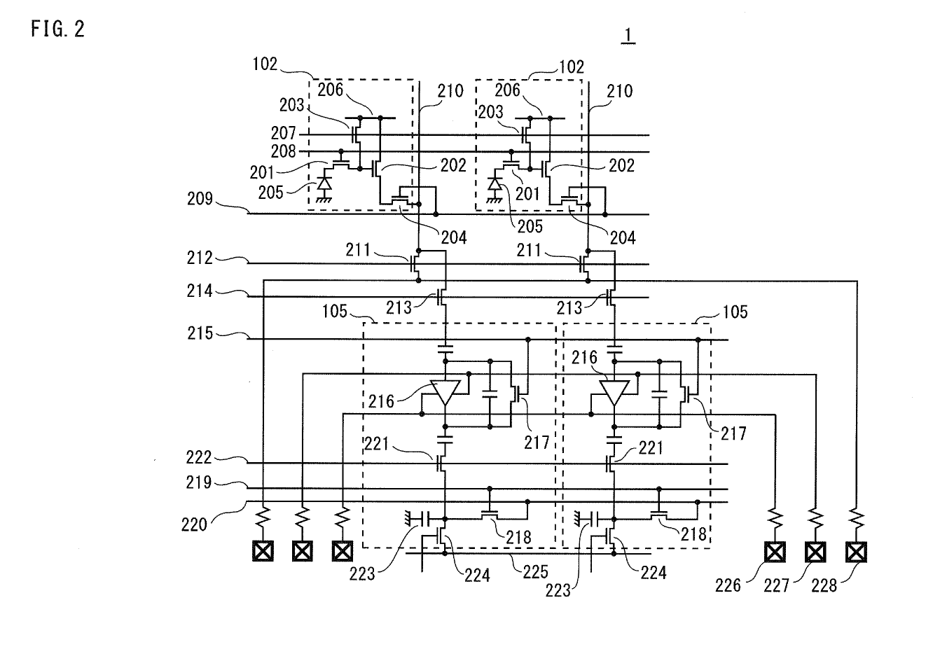

FIG. 2 is a circuit diagram illustrating the structure of the solid-state imaging apparatus 1. Note that FIG. 2 illustrates only one row and two columns of pixel cells 102 among the pixel cells 102 constituting the pixel array 103. This applies to other circuit diagrams provided by the present application. Also note that the reference numbers assigned to circuit elements in the present embodiment are used in common to represent the corresponding circuit elements in the other embodiments.

As shown in FIG. 2, each of the pixel cells 102 includes a pixel transfer transistor 201, a pixel source follower transistor 202, a pixel reset transistor 203, a pixel selection transistor 204, and a photodiode 205.

The photodiode 205 performs a photoelectric conversion onto incident light to generate charge whose amount depends on the amount of the incident light. The pixel transfer transistor 201 is controlled to turn ON or OFF by a pixel transfer control line 208, and supplies the charge generated by the photodiode 205 to a gate electrode of the pixel source follower transistor 202.

The pixel source follower transistor 202 is connected via its source electrode to a pixel power source 206, and outputs a pixel signal whose level depends on the amount of charge generated by the photodiode 205.

The pixel selection transistor 204 is controlled to turn ON or OFF by a pixel selection control line 209, and is used for a selection of a row. The pixel selection transistor 204 outputs the pixel signal output from the pixel source follower transistor 202, to a vertical common signal line 210. The pixel reset transistor 203 is controlled to turn ON or OFF by a pixel reset control line 207, and resets a gate voltage of the pixel source follower transistor 202 to a supply voltage of the pixel power source 206.

A current source transistor 211 is connected via its drain electrode to the vertical common signal line 210, is connected via its source electrode and a ground line for current source transistor to a grounding bonding pad 228, and is controlled to turn ON or OFF by a current source transistor bias line 212.

A vertical common signal line switch transistor 213 is controlled to turn ON or OFF by a switch transistor control line 214, and enables or disables an electrical connection between the vertical common signal line 210 and the unit column circuit 105.

Each of the unit column circuits 105 includes a column amplifier 216, a column amplifier reset transistor 217, a clamp transistor 218, a sample/hold transistor 221, a sample/hold capacitor 223, and a horizontal selection switch transistor 224.

The column amplifier 216 amplifies a pixel signal input through the vertical common signal line 210 and outputs the amplified signal. The column amplifier reset transistor 217 is controlled to turn ON or OFF by a column amplifier reset control line 215, and resets the column amplifier 216.

The sample/hold capacitor 223 accumulates the pixel signals that have been amplified by the column amplifier 216. The sample/hold transistor 221 is controlled to turn ON or OFF by a sample/hold control line 222, and causes an amount of the pixel signals accumulated in the sample/hold capacitor 223 to be fixed by disabling an electrical connection between the column amplifier 216 and the sample/hold capacitor 223.

The clamp transistor 218 is controlled to turn ON or OFF by a clamp control line 219, and fixes the potential of the sample/hold capacitor 223 to a clamp potential supplied from a clamp voltage supply line 220 before pixel signals are read from pixel cells 102.

The horizontal selection switch transistor 224 is controlled to turn ON or OFF by the horizontal scanning circuit 107. The horizontal selection switch transistor 224 is turned ON after the amount of the pixel signals accumulated in the sample/hold capacitor 223 is fixed, and outputs the pixel signals accumulated in the sample/hold capacitor 223 to a horizontal common signal line 225.

A bonding pad 226, to which a column amplifier ground line is connected, is used to connect the column amplifier 216 to the ground. A bonding pad 227, to which a column amplifier power source line is connected, is used to apply a predetermined power source voltage to the column amplifier 216.

### (1-2) Operation of Solid-State Imaging Apparatus

Next, a description is given of the operation of the solid-state imaging apparatus 1.

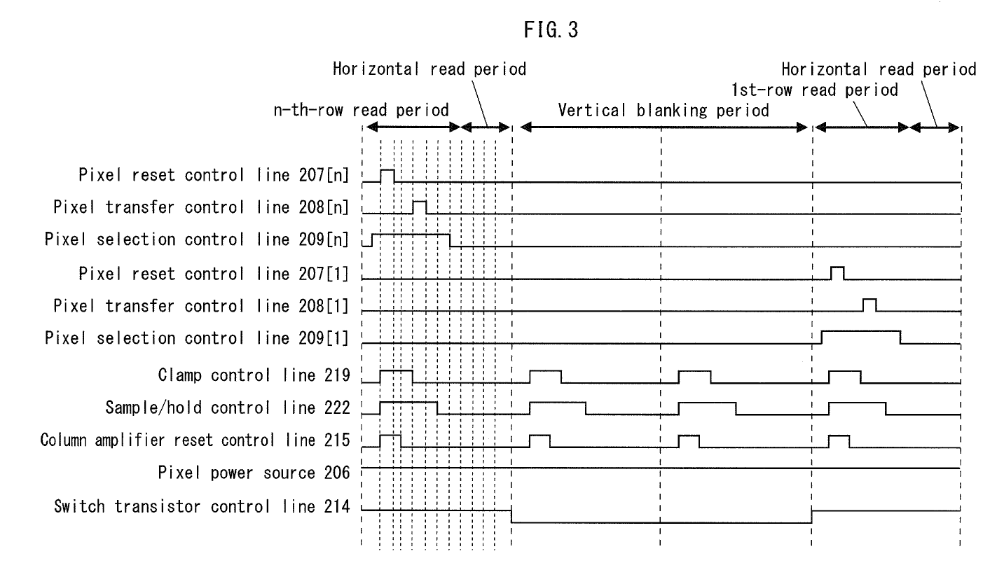

FIG. 3 is a timing chart illustrating the operation of the solid-state imaging apparatus 1. As shown in FIG. 3, the operation period of the solid-state imaging apparatus 1 is roughly divided into a row read period, a horizontal read period, and a vertical blanking period.

In the row read period, first the pixel selection control line 209 of a target row is driven high (H), and pixel signals of the pixel cells 102 in the target row are read into the respectively corresponding unit column circuits 105. After the reading is completed, the pixel selection control line 209 is pulled low (L), and the row read period for the target row ends. In the horizontal read period, the pixel signals held by the unit column circuits 105 are selected one by one, and are output from the output amplifier 109.

The vertical blanking period is a period from after the end of the horizontal read period of the last row (in this example, the n^{th} row) to before the start of the row read period of the first row.

(a) Operation of Row Read Period

First, the operation of the row read period is explained.

As described above, while the pixel selection control line 209 of a target row from which the pixel signals are read is driven “H”, the pixel reset control line 207, clamp control line 219, sample/hold control line 222 and column amplifier reset control line 215 are driven high (see FIG. 3).

With this structure, when the pixel reset transistor 203 is turned ON, the gate potential of the pixel source follower transistor 202 is reset to the potential (pixel power source potential) of the pixel power source 206. Also, the clamp transistor 218 is turned ON and the potential of the sample/hold capacitor 223 is fixed to the potential (clamp potential) supplied from the clamp voltage supply line 220, and the column amplifier 216 is reset as well.

After this, the pixel reset control line 207, column amplifier reset control line 215, clamp control line 219 are pulled low one by one in this order. This causes the pixel reset transistor 203 to turn OFF, and causes the unit column circuit 105 to be kept in the clamp state.

Subsequently, when the pixel transfer control line 208 is driven high, the pixel transfer transistor 201 is turned ON, and electrons accumulated in the photodiode 205 are transferred to the gate of the pixel source follower transistor 202. This causes the change in the gate potential to be conveyed to the unit column circuit 105 via the vertical common signal line 210, and the potential change is amplified by the column amplifier 216, and then a potential corresponding to the amount of pixel signals is held by the sample/hold capacitor 223.

After this, when the sample/hold control line 222 is pulled low, the sample/hold transistor 221 is turned OFF, and the amount of the pixel signals accumulated in the sample/hold capacitor 223 is fixed. The operations described above are executed in parallel for all the columns of the pixel array 103. During the horizontal read period after the amount of signals is fixed, the horizontal selection switch transistor 224 is selected sequentially for each column, and the sample/hold capacitor 223 is read to the horizontal common signal line 225.

(b) Operation in Vertical Blanking Period

As shown in FIG. 2, the solid-state imaging apparatus 1 is characterized in that the vertical common signal line switch transistors 213 are provided on the vertical common signal lines 210 between the pixel cells 102 and the unit column circuits 105 so that the transfer of pixel signals to the unit column circuits 105 can be shut off.

The vertical common signal line switch transistor 213 is turned OFF when effective pixels are not read (in this example, the vertical common signal line switch transistor 213 is turned OFF during the vertical blanking period). During this OFF period, the data for correcting the vertical fixed pattern noise is obtained. A signal for controlling ON/OFF of the vertical common signal line switch transistor 213 may be supplied from outside the solid-state imaging apparatus 1, or may be generated inside the solid-state imaging apparatus 1.

In the present embodiment, to obtain the data for correcting the vertical fixed pattern noise, first the switch transistor control line 214 is pulled low during the vertical blanking period. This causes the vertical common signal line switch transistor 213 to be turned OFF.

Next, the clamp control line 219, sample/hold control line 222, and column amplifier reset control line 215 are driven high. This causes the clamp transistor 218 to be turned ON, and the potential of the sample/hold capacitor 223 is fixed to the clamp potential of the clamp voltage supply line 220. Also, the column amplifier reset transistor 217 is turned ON, and the column amplifier 216 is reset.

Following this, the column amplifier reset control line 215 and the clamp control line 219 are pulled low one by one in this order. This causes the column amplifier reset transistor 217 and the clamp transistor 218 to be turned OFF, and the unit column circuit 105 is kept in the clamp state.

While the unit column circuit 105 is kept in the clamp state, the column amplifier 216 outputs a voltage whose value varies depending on processing variation, and the sample/hold capacitor 223 accumulates charges whose amount varies depending on processing variation.

Subsequently, when the sample/hold control line 222 is pulled low, the sample/hold transistor 221 is turned OFF, and the amount of the pixel signals accumulated in the sample/hold capacitor 223 is fixed. After the amount of accumulated pixel signals is fixed, the horizontal scanning circuit 107 selects the horizontal selection switch transistors 224 one by one for each column, and the sample/hold capacitor 223 is read to the horizontal common signal line 225, amplified by the output amplifier 109, and then output. The value of this output is used to correct the vertical fixed pattern noise.

### (1-3) Advantageous Effects of Present Embodiment

As described above, there is the following problem in the conventional technology in which the source follower output, which is obtained in the state where the gate potential of the pixel source follower transistor 202 of the pixel cells 102 or of a transistor approximately equivalent to the pixel source follower transistor 202 is fixed, is used as the data for correcting the vertical fixed pattern noise.

That is to say, due to the necessity that the pixel source follower transistors 202 need to be laid out at the pixel pitch, processing variation is likely to occur. This decreases the accuracy of the data for correcting the vertical fixed pattern noise.

Also, in the case where an average of outputs of a lot of pixel source follower transistors 202 is calculated to improve the accuracy of the data for correcting the vertical fixed pattern noise, the layout area of the solid-state imaging apparatus needs to be increased.

On the other hand, the vertical fixed pattern noise generally occurs due to processing variation in the unit column circuits 105.

For example, if variation is present in the threshold voltage or the size of the sample/hold transistor 221, variation occurs in the amount of distributed charges in a channel when the sample/hold transistor 221 is turned OFF after pixel signals are read. This variation in the amount of distributed charges becomes an offset element, and the vertical fixed pattern noise occurs.

In contrast to this, when pixel signals are read into the unit column circuits 105, there is hardly a factor to cause variation between the unit column circuits 105. Also, reading from the pixel cells is performed by the source follower transistors, and variation in the threshold voltage between the power source transistors is removed by the noise cancellation by the correlative double sampling.

Accordingly, since there is no variation in the outputs from the source follower circuit on the pixel cell side, the problem of the vertical fixed pattern noise can be solved even without using these outputs as the data for correcting the vertical fixed pattern noise.

In the present embodiment, the transfer of pixel signals from the pixel cells is shut off while the data for correcting the vertical fixed pattern noise is obtained. This enables the unit column circuits to perform the signal processing in the same manner as the reading of effective pixels, in the state where the input potential of the unit column circuits are kept to the potential immediately before the shut-off.

In the present embodiment, the vertical common signal line switch transistor 213 is turned OFF during the vertical blanking period so that the input potential of the unit column circuits are kept to the potential immediately before the shut-off. Also, in this state, the unit column circuits 105 are caused to perform the signal processing in the same manner as in the pixel reading period, thereby enabling the data for correcting the vertical fixed pattern noise to be obtained.

The above-structure of this embodiment eliminates the need to add dummy pixels or source follower transistors to obtain the data for correcting the vertical fixed pattern noise, and thus reduces the layout area of the solid-state imaging apparatus 1.

Also, the conventional technology using dummy pixels requires a correction bias circuit for fixing the gate potential of the dummy pixel transistors 1721 to an appropriate potential. This correction bias circuit has a high load carrying capacity since the correction bias circuit is connected to the dummy pixel transistors 1721 of all columns.

### [2] Second Embodiment

The following describes the second embodiment of the present invention. The solid-state imaging apparatus of the present embodiment has approximately the same structure as the solid-state imaging apparatus of the first embodiment, except that a plurality of photodiodes are provided in one pixel cell. In the following, the structure is explained centering on the difference.

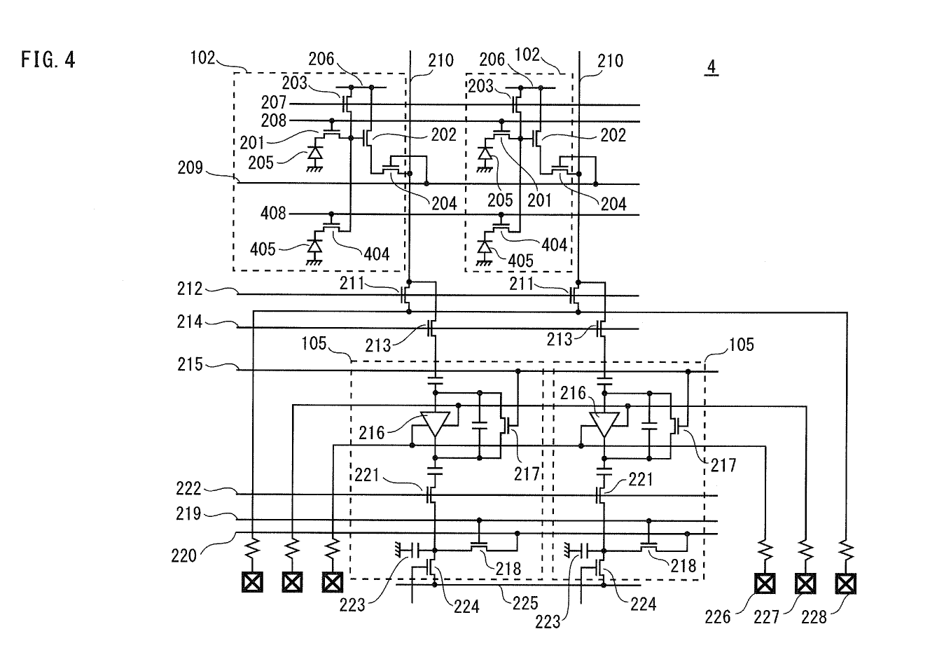

FIG. 4 is a circuit diagram illustrating the structure of the solid-state imaging apparatus in the present embodiment. As shown in FIG. 4, a solid-state imaging apparatus 2 of the present embodiment has a so-called 2-pixel 1-cell structure in which two photodiodes 205 share the pixel source follower transistor 202, pixel reset transistor 203, and pixel selection transistor 204.

Even with the 2-pixel 1-cell structure, if the vertical common signal line switch transistor 213 is provided and operated in the same manner as in the first embodiment, it is possible to obtain, with accuracy, the data for correcting the vertical fixed pattern noise which is caused by variation in property between the unit column circuits 105. The structure also reduces the layout area.

Note that, needless to say, the number of photodiodes 205 that share the pixel source follower transistor 202 and the like is not limited to two, and if three or more photodiodes are provided for one pixel, the same advantageous effect of the present embodiment can be obtained.

### [3] Third Embodiment

The following describes the third embodiment of the present invention. The solid-state imaging apparatus of the present embodiment has approximately the same structure as the solid-state imaging apparatus of the second embodiment, except that the data for correcting the vertical fixed pattern noise is obtained by applying a fixed voltage as input to the unit column circuits 105. In the following, the structure is explained centering on the difference.

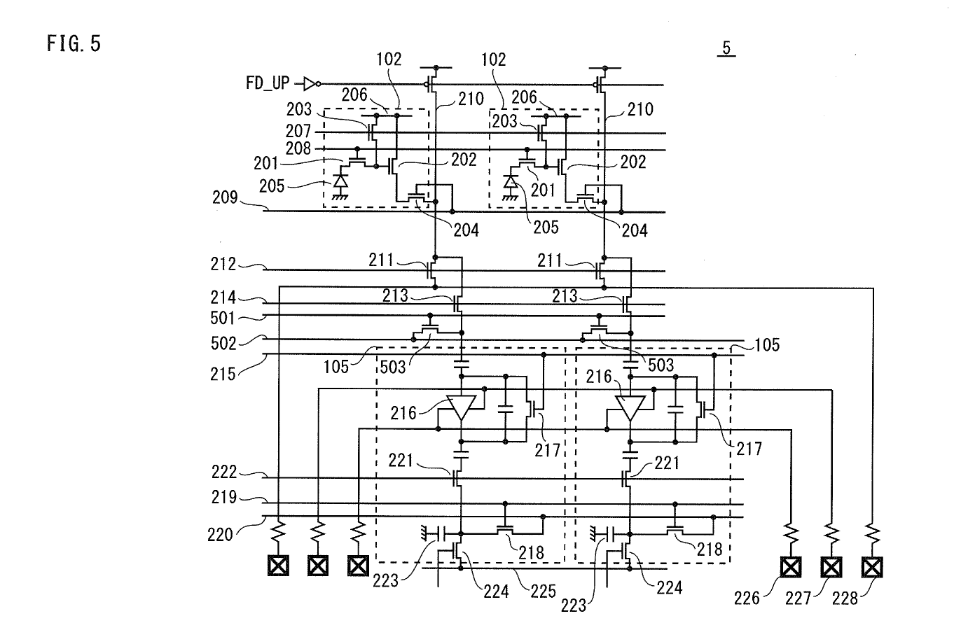

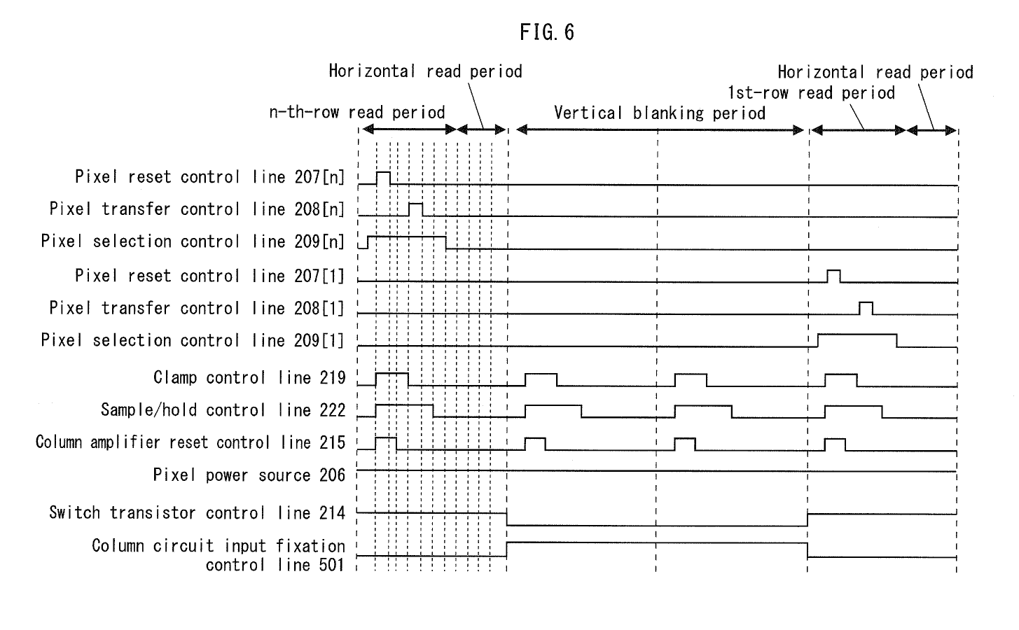

FIG. 5 is a circuit diagram illustrating the structure of the solid-state imaging apparatus in the present embodiment. FIG. 6 is a timing chart illustrating the operation of the solid-state imaging apparatus in the present embodiment.

As shown in FIG. 5, a solid-state imaging apparatus 4 of the present embodiment further includes a column circuit input fixation bias line 502 and column circuit input fixation transistors 503 in addition to the structural elements of the first embodiment. The column circuit input fixation bias line 502 fixes the inputs for the unit column circuits 105 to a predetermined voltage. Also, the column circuit input fixation transistors 503 enable or disable electrical connections between the column circuit input fixation bias line 502 and the unit column circuits 105.

In the above first and second embodiments, when the vertical common signal line switch transistor 213 is turned OFF, the input to the unit column circuit 105 is fixed and the unit column circuit 105 is in an electrically floating state. The input potential of the unit column circuit 105 in the electrically floating state can vary depending on the layout or processing, due to a coupling with another control line or power source, or due to the effect of leak currents from the MOS capacitor diffusion regions.

In contrast, in the present embodiment, the column circuit input fixation transistors 503 is controlled from outside the solid-state imaging apparatus 4, or by using an internal circuit of the solid-state imaging apparatus 4 so that the inputs for the unit column circuits 105 are fixed to the potential of the column circuit input fixation bias line 502 during the vertical blanking period. With this structure, the inputs for the unit column circuits 105 are stabilized, and the data for correcting the vertical fixed pattern noise can be obtained with high accuracy.

Note that, needless to say, even in the case where the multiple-pixel 1-cell structure described in the second embodiment is applied to the present embodiment, it is possible to obtain correction data with high accuracy. Also, as apparent from FIG. 5, even if the structure of the present embodiment is adopted, an increase in layout area or power consumption does not occur.

### [4] Fourth Embodiment

The following describes the fourth embodiment of the present invention. The solid-state imaging apparatus of the present embodiment has approximately the same structure as the solid-state imaging apparatus of the second embodiment, but the present embodiment is characterized in that the ground potential is input to the unit column circuits 105 when the data for correcting the vertical fixed pattern noise is obtained. In the following, the structure is explained centering on the characteristic of the present embodiment.

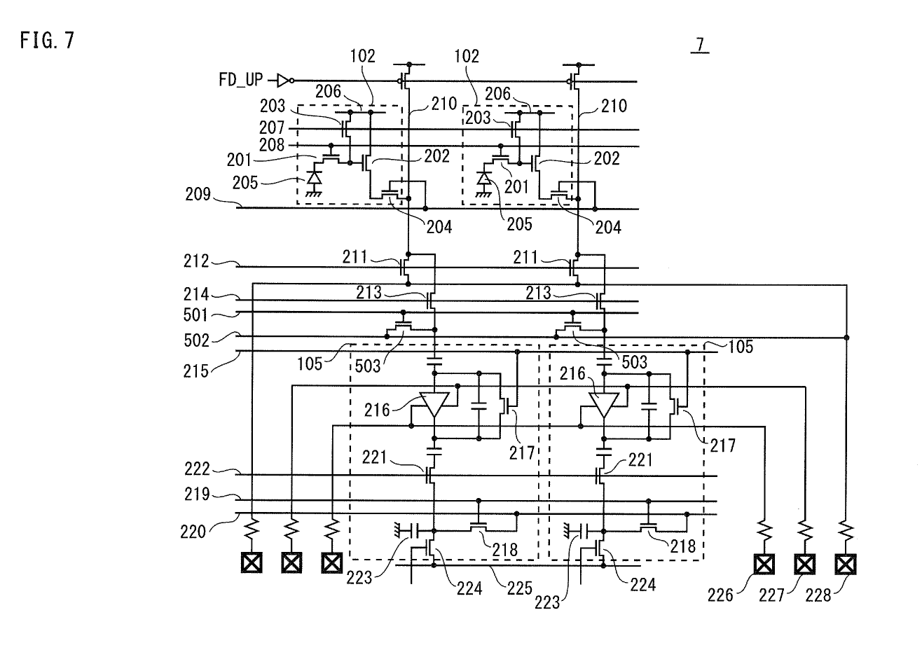

FIG. 7 is a circuit diagram illustrating the structure of the solid-state imaging apparatus in the present embodiment. As shown in FIG. 7, in a solid-state imaging apparatus 5 of the present embodiment, the column circuit input fixation bias line 502 that inputs a predetermined voltage to the unit column circuits 105 when the data for correcting the vertical fixed pattern noise is obtained are connected to the bonding pad 228 via current source transistor ground lines.

The current source transistor ground lines connected to the bonding pad 228 have low impedance, and thus can input a predetermined voltage, which is not likely to be affected by noise, to the unit column circuits 105. This makes it possible to improve the accuracy with which the data for correcting the vertical fixed pattern noise is obtained. Note that a similar effect can be obtained even when the potential of the column circuit input fixation bias line 502 is connected to lines with low impedance, such as the power source lines and the bias voltage lines, other than the current source transistor ground lines.

Note that, even in the case where the multiple-pixel 1-cell structure described in the second embodiment is applied to the present embodiment, it is possible to obtain a similar effect by connecting the column circuit input fixation bias line 502 to lines with low impedance.

### [5] Fifth Embodiment

The following describes the fifth embodiment of the present invention. The solid-state imaging apparatus of the present embodiment has approximately the same structure as the solid-state imaging apparatus of the second embodiment, but the present embodiment is characterized in that only one end of each of the column circuit input fixation bias lines is grounded. In the following, the structure is explained centering on the characteristic of the present embodiment.

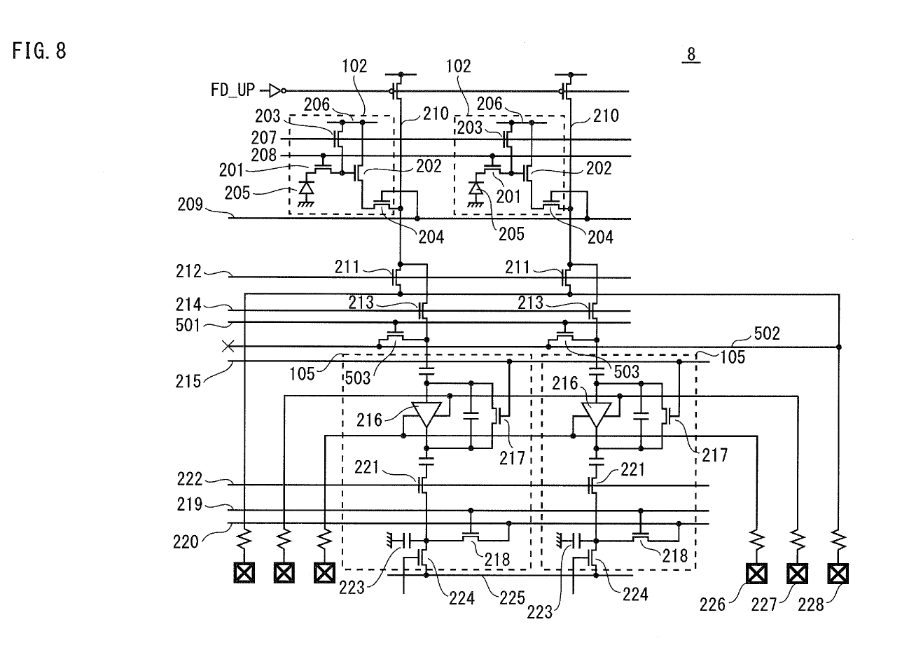

FIG. 8 is a circuit diagram illustrating the structure of the solid-state imaging apparatus in the present embodiment. As shown in FIG. 8, in a solid-state imaging apparatus 7 of the present embodiment, only one end of the column circuit input fixation bias line 502, which is provided to fix the inputs for the unit column circuits 105 to a predetermined voltage, is connected to the bonding pad 228 via a power source transistor ground line, and the other end is electrically shut off from the other ground lines.

If both ends of each of the column circuit input fixation bias lines are connected to different ground lines, a very low potential is generated between both ends of the column circuit blocks 106 depending on consumption currents of other circuit blocks because the impedance of the ground lines is not “0”, and a current flows. This current causes a shading to be generated in the input voltage of the unit column circuits 105 in the horizontal direction. This causes the accuracy of the data for correcting the vertical fixed pattern noise to be reduced.

In contrast to this, in the present embodiment, only one end of the column circuit input fixation bias line 502 is connected to a ground line. This prevents a current from flowing between both ends of the column circuit blocks 106, and restricts generation of the shading in the horizontal direction.

As far as it is a line with low impedance for input fixation voltage, a power source line or a bias voltage line can be used to obtain a similar effect.

With the structure of the present embodiment, the data for correcting the vertical fixed pattern noise can be obtained with accuracy even for the pixels in the multiple-pixel 1-cell structure. Also, since there is no need to add dummy pixels or source follower transistors, the layout area can be reduced.

### [6] Sixth Embodiment

The following describes the sixth embodiment of the present invention. The solid-state imaging apparatus of the present embodiment has approximately the same structure as the solid-state imaging apparatus of the second embodiment, but the present embodiment is characterized in that the column circuit input fixation bias lines are connected to a dedicated bonding pad. In the following, the structure is explained centering on the characteristic of the present embodiment.

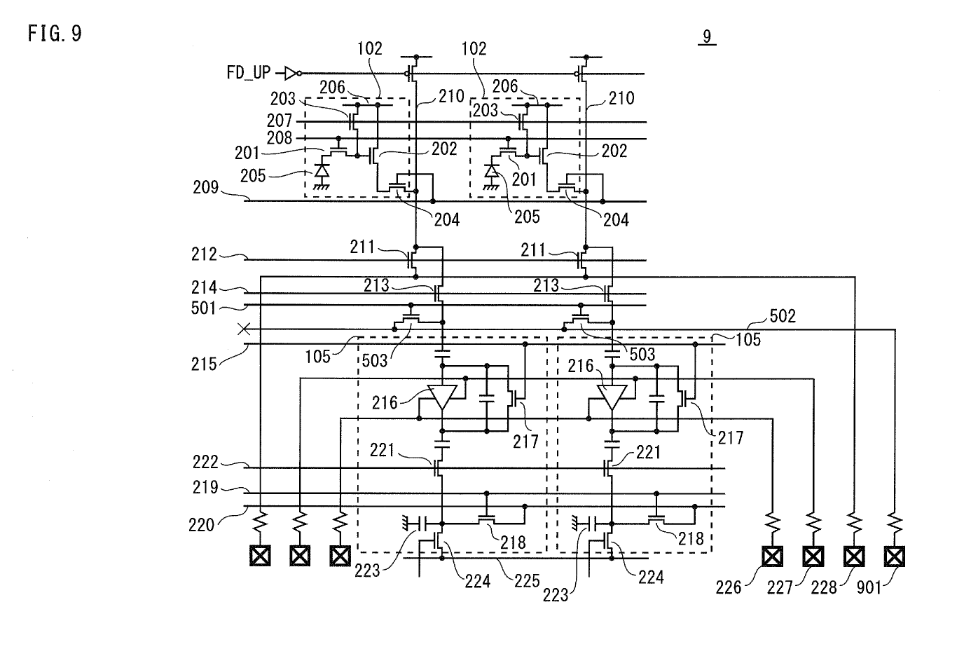

FIG. 9 is a circuit diagram illustrating the structure of the solid-state imaging apparatus in the present embodiment. As shown in FIG. 8, in a solid-state imaging apparatus 8 of the present embodiment, one end of the column circuit input fixation bias line 502 is connected to a grounding bonding pad 901. The bonding pad 901 is connected only to the column circuit input fixation bias line 502, and not to any other lines. The other end of the column circuit input fixation bias line 502 is not connected to any line.

With this structure of the present embodiment, the potential of the column circuit input fixation bias line 502 is not affected by current variations in other circuit blocks. This improves the accuracy of the data for correcting the vertical fixed pattern noise. Note that the bonding pad 901 is not limited to a pad for grounding, but a similar effect can be obtained if the bonding pad 901 is for power source or for bias voltage.

Note that, even in the case where the multiple-pixel 1-cell structure is adopted in the present embodiment, the same advantageous effect can be obtained, and the advantageous effect that the layout area can be reduced is obtained as well since dummy pixels or the like are not required.

### [7] Seventh Embodiment

The following describes the seventh embodiment of the present invention. The solid-state imaging apparatus of the present embodiment has approximately the same structure as the solid-state imaging apparatus of the first embodiment, but the present embodiment is characterized in that the pixel cells for correcting the vertical fixed pattern noise are connected to the vertical common signal lines 210. In the following, the structure is explained centering on the characteristic of the present embodiment.

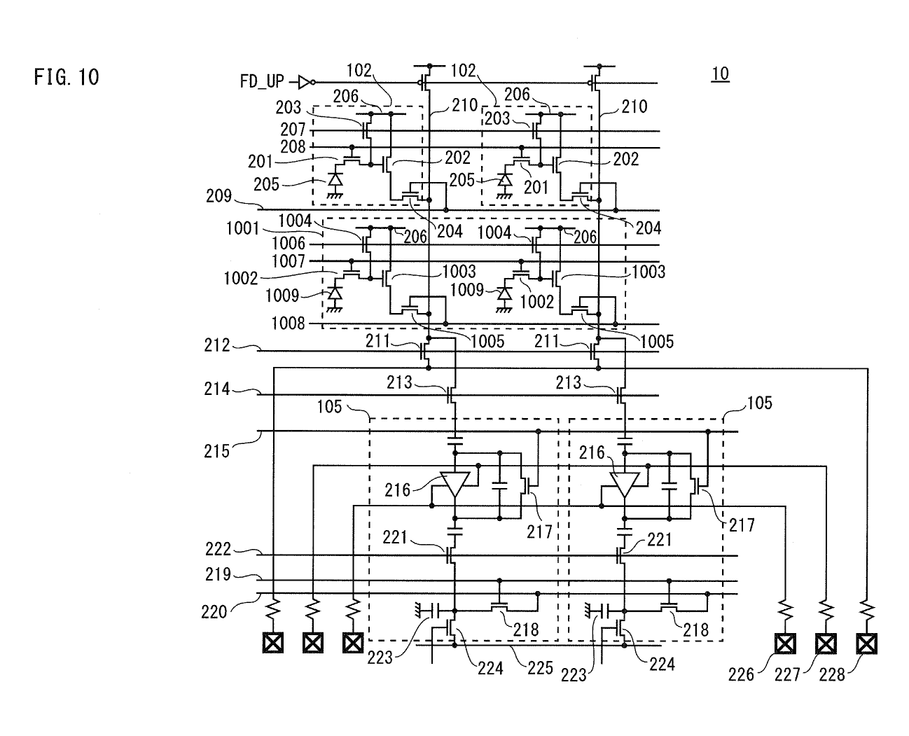

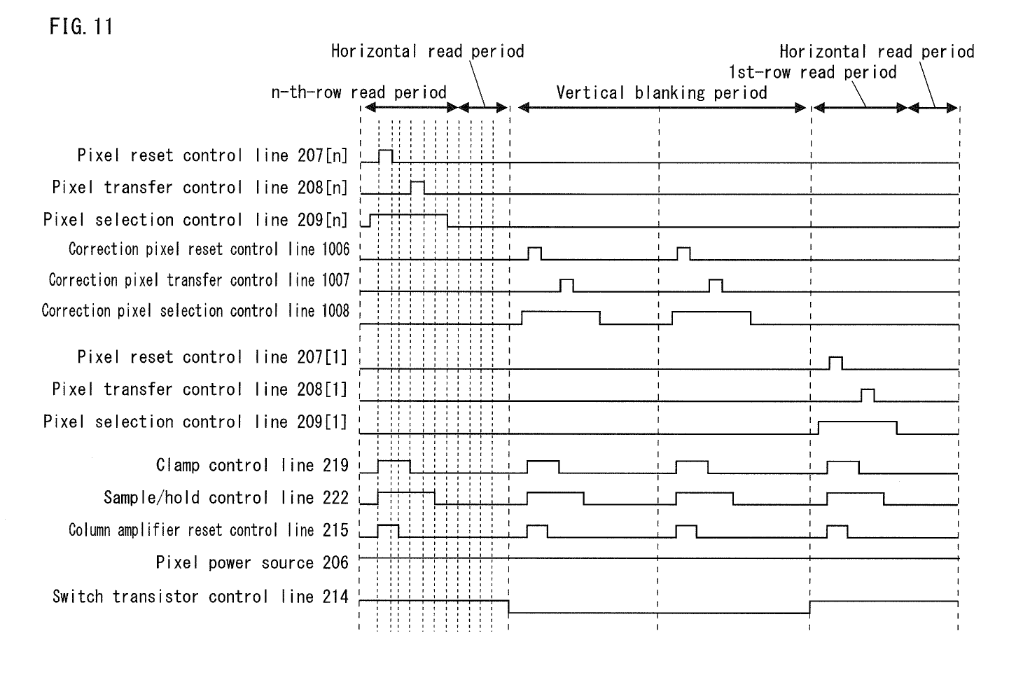

FIG. 10 is a circuit diagram illustrating the structure of the solid-state imaging apparatus in the present embodiment. FIG. 11 is a timing chart illustrating the operation of the solid-state imaging apparatus in the present embodiment.

As shown in FIG. 10, in a solid-state imaging apparatus 9 of the present embodiment, rows of correction pixel cells 1001 are provided in addition to the rows of effective pixels. The correction pixel cells 1001 are connected to respectively corresponding vertical common signal lines 210.

Each of the correction pixel cells 1001 includes a correction pixel transfer transistor 1002, a correction pixel source follower transistor 1003, a correction pixel reset transistor 1004, a correction pixel selection transistor 1005, and a correction photodiode 1009.

The correction photodiode 1009 performs a photoelectric conversion onto incident light to generate charge whose amount depends on the amount of the incident light. The correction pixel transfer transistor 1002 is controlled to turn ON or OFF by a correction pixel transfer control line 1007, and supplies the charge generated by the correction photodiode 1009 to a gate electrode of the correction pixel source follower transistor 1003.

The correction pixel source follower transistor 1003 is connected to the pixel power source 206, and outputs a pixel signal whose level depends on the amount of charge generated by the correction photodiode 1009.

The correction pixel selection transistor 1005 is controlled to turn ON or OFF by a correction pixel selection control line 1008, and is used for a selection of a row. The correction pixel selection transistor 1005 outputs the pixel signal output from the correction pixel source follower transistor 1003, to the vertical common signal line 210.

The correction pixel reset transistor 1004 is controlled to turn ON or OFF by a correction pixel reset control line 1006, and resets a gate voltage of the correction pixel source follower transistor 1003 to a supply voltage of the pixel power source 206. It should be noted here that light from outside is not necessarily input to the correction photodiode 1009.

The correction pixel cells 1001 are read in a period during which the data for correcting the vertical fixed pattern noise is obtained, which is the vertical blanking period in the example of FIG. 11. When it is intended to remove the effect of random noise, it is necessary to read the correction pixel cells 1001 a plurality of times, and calculate an average of the read values. FIG. 11 illustrates an example in which the correction pixel cells 1001 are read twice. However, not limited to this, the number of readings needs to be determined appropriately by taking account of the effect of random noise.

In general, in a set of circuit blocks, among the circuit blocks constituting a solid-state imaging apparatus, in which a power source and a ground line have impedance in common inside and outside a chip, when a current change occurs in a circuit block, the current change affects another circuit block via the impedance common to the power source and the ground line. The effect from another circuit block via the impedance common to the power source and the ground line is considered to contribute to the vertical fixed pattern noise as well.

In contrast, in the present embodiment, when the data for correcting the vertical fixed pattern noise is obtained while a connection between the vertical common signal line 210 and the unit column circuit 105 is shut off by the vertical common signal line switch transistor 213, the correction pixel cells 1001 connected to the vertical common signal line 210 are read (see FIG. 11).

With this structure, with regard to the effect (for example, a change in the current of power source transistors for pixels) that the unit column circuits 105 would receive via the common impedance when the effective pixels are read, there is no difference in the effect between reading of the effective pixels and obtaining the correction data. This prevents the accuracy of the data for correcting the vertical fixed pattern noise from being degraded by the horizontal shading.

Note that, different from the dummy pixels used in the conventional technology, outputs of the correction pixel cells 1001 are not used as data. Therefore there is no need to increase the processing accuracy of the correction pixel cells 1001. Thus while the use of dummy pixels of the conventional technology requires a lot of rows of dummy pixels and the process of calculating the average, the use of the correction pixel cells 1001 of the present embodiment requires only one row of correction pixel cells 1001.

Needless to say, even in the case where the multiple-pixel 1-cell structure is applied to the present embodiment, it is possible to obtain the data for correcting the vertical fixed pattern noise with high accuracy.

### [8] Eighth Embodiment

The following describes the eighth embodiment of the present invention. The solid-state imaging apparatus of the present embodiment is a combination of the solid-state imaging apparatuses described in the second and seventh embodiments.

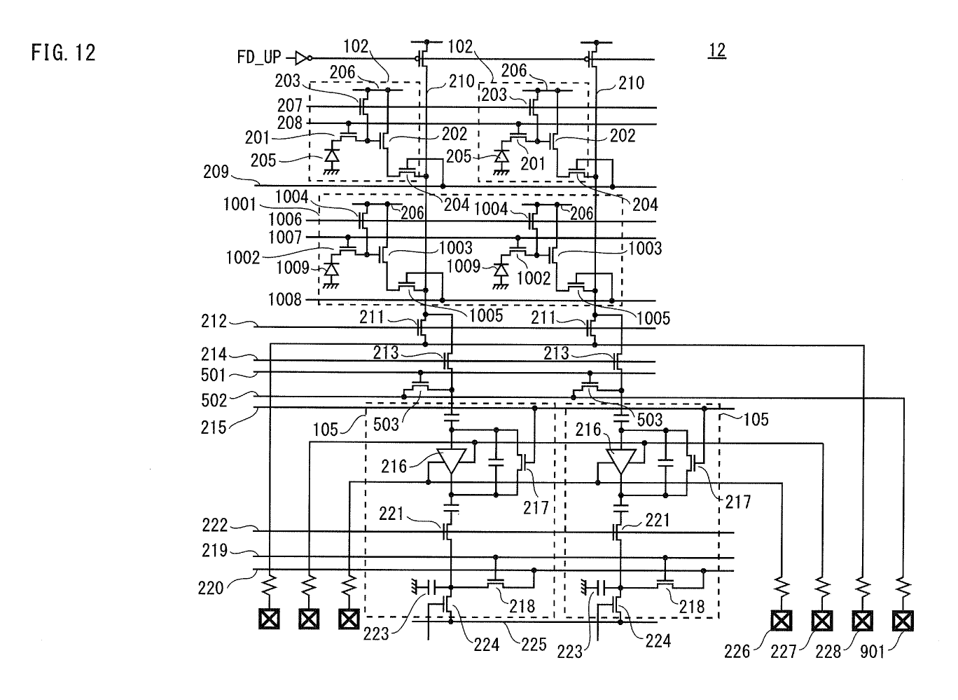

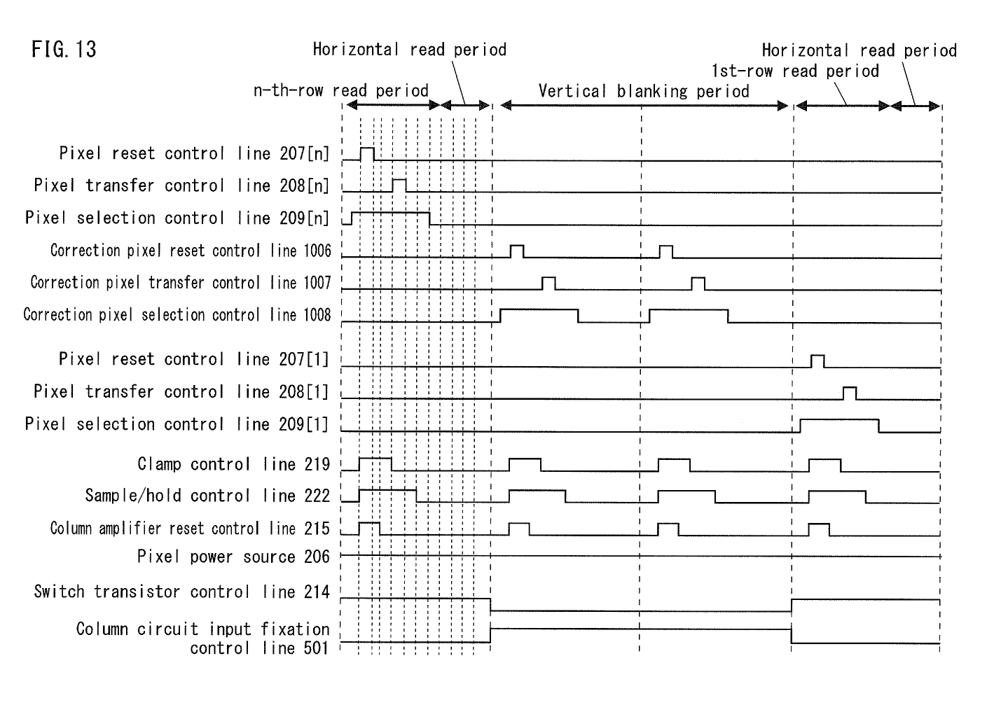

FIG. 12 is a circuit diagram illustrating the structure of the solid-state imaging apparatus in the present embodiment. FIG. 13 is a timing chart illustrating the operation of the solid-state imaging apparatus in the present embodiment. As shown in FIG. 12, in the solid-state imaging apparatus 9, the correction pixel cells 1001 are connected to corresponding vertical common signal lines 210 respectively.

Also, as shown in FIG. 13, when the data for correcting the vertical fixed pattern noise is obtained, a column circuit input fixation control line 501 is driven high, and this causes a predetermined voltage to be input to the unit column circuits 105 via the column circuit input fixation bias line 502.

With the above structure and operation, it is possible to improve the accuracy of the data for correcting the vertical fixed pattern noise. Note that a similar effect can be obtained if the structure of the present embodiment is applied to the solid-state imaging apparatus of the multiple-pixel 1-cell structure.

### [9] Ninth Embodiment

The following describes the ninth embodiment of the present invention. The solid-state imaging apparatus of the present embodiment has approximately the same structure as the solid-state imaging apparatus of the seventh embodiment, except that each effective pixel does not include the pixel selection transistor 204. In the following, the structure is explained centering on the difference.

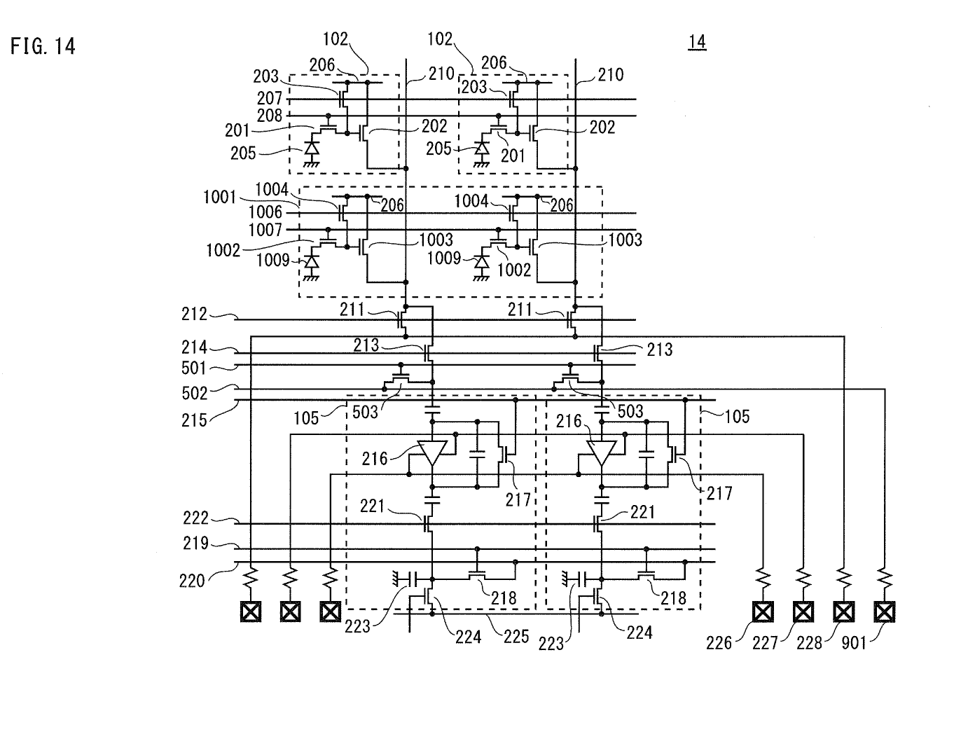

FIG. 14 is a circuit diagram illustrating the structure of the solid-state imaging apparatus in the present embodiment. As shown in FIG. 14, a solid-state imaging apparatus 13 of the present embodiment has almost the same structure as the solid-state imaging apparatus 9 of the seventh embodiment, except that it does not include the pixel selection transistor 204, pixel selection control line 209, correction pixel selection transistor 1005, and correction pixel selection control line 1008.

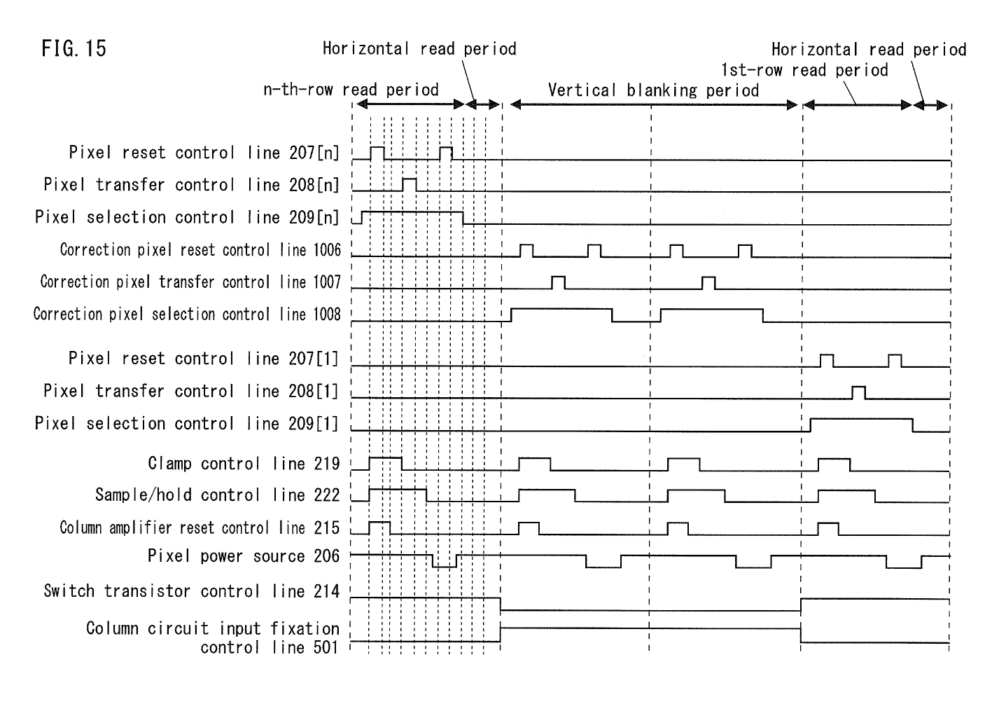

FIG. 15 is a timing chart illustrating the operation of the solid-state imaging apparatus in the present embodiment. As shown in FIG. 15, after the pixel transfer control line 208 is driven high and the pixel signals are read, the pixel power source 206 is pulled low. When the pixel reset control line 207 is driven high in this state, the pixel reset transistor 203 is turned ON, and the output of the corresponding pixel is reset to the non-selection state. After this, the pixel power source 206 is driven high and the horizontal read process for the corresponding row is performed.

With this structure, if the data for correcting the vertical fixed pattern noise is obtained in the state where a connection between the vertical common signal line 210 and the unit column circuit 105 is shut off by the vertical common signal line switch transistor 213, it is also possible to improve the accuracy of the correction data without increasing the layout area of the solid-state imaging apparatus 13.

### [10] Tenth Embodiment

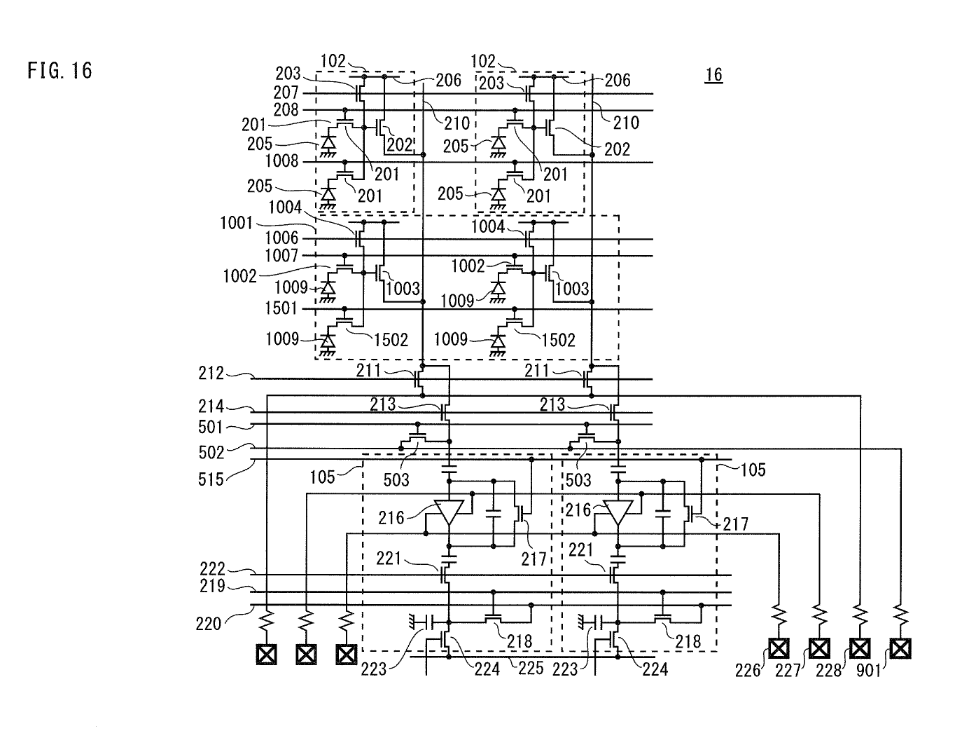

The following describes the tenth embodiment of the present invention. The solid-state imaging apparatus of the present embodiment has approximately the same structure as the solid-state imaging apparatus of the ninth embodiment, except that each pixel has the multiple-pixel 1-cell structure and includes a plurality of photodiodes (see FIG. 16).

With this structure, if the data for correcting the vertical fixed pattern noise is obtained in the state where a connection between the vertical common signal line 210 and the unit column circuit 105 is shut off by the vertical common signal line switch transistor 213, it is also possible to improve the accuracy of the correction data without increasing the layout area of the solid-state imaging apparatus 13.

FIG. 16 illustrates a case where two photodiodes are included in each pixel. However, needless to say, the present invention is not limited to this structure, and a similar effect can be obtained even when three or more photodiodes are included in each pixel.

### INDUSTRIAL APPLICABILITY

The solid-state imaging apparatus of the present invention is useful as a

MOS-type solid-state imaging apparatus for solving the problem of the fixed column pattern noise which appears like a vertical line.

### REFERENCE SIGNS LIST

201 pixel transfer transistor

202 pixel source follower transistor

203 pixel reset transistor

204 pixel selection transistor

205 photodiode

206 pixel power source

207 pixel reset control line

208 pixel transfer control line

209 pixel selection control line

210 vertical common signal line

211 current source transistor

212 current source transistor bias line

213 vertical common signal line switch transistor

214 switch transistor control line

215 column amplifier reset control line

216 column amplifier

217 column amplifier reset transistor

218 clamp transistor

219 clamp control line

220 clamp voltage supply line

221 sample/hold transistor

222 sample/hold control line

223 sample/hold capacitor

224 horizontal selection switch transistor

225 horizontal common signal line

226-228, 901 bonding pad

501 column circuit input fixation control line

502 column circuit input fixation bias line

503 column circuit input fixation transistor

1001 correction pixel cell

1002 correction pixel transfer transistor

1003 correction pixel source follower transistor

1004 correction pixel reset transistor

1005 correction pixel selection transistor

1006 correction pixel reset control line

1007 correction pixel transfer control line

1008 correction pixel selection control line

1009 correction photodiode

1. A solid-state imaging apparatus of a MOS (Metal Oxide Semiconductor) type in which a plurality of pixel cells are arranged two-dimensionally in rows and columns, the solid-state imaging apparatus comprising:
vertical common signal lines each connected to pixel cells in a different column;
unit column circuits connected to the vertical common signal lines on a one-to-one basis, and each including an amplifier and a capacitor, the amplifier amplifying pixel signals input from pixel cells in a column via a corresponding vertical common signal line, and the capacitor holding the pixel signals amplified by the amplifier;
switches each provided between a vertical common signal line and a unit column circuit, and enabling and disabling an electrical connection between the vertical common signal line and the unit column circuit; and
a reading unit resetting each capacitor and reading outputs from the unit column circuits while the electrical connection is disabled and shut off by each switch.

2. The solid-state imaging apparatus of claim 1 further comprising:
a reset unit resetting each capacitor by applying a predetermined voltage thereto.

3. The solid-state imaging apparatus of claim 1 further comprising:
an input unit inputting a predetermined potential to each unit column circuit while the electrical connection is shut off by the switch.

4. The solid-state imaging apparatus of claim 3, wherein
the predetermined potential is a ground potential.

5. The solid-state imaging apparatus of claim 3, wherein
the predetermined potential is a potential of current received by a bonding pad that is not electrically connected to any line that is connected to another circuit in the apparatus.

6. The solid-state imaging apparatus of claim 3, wherein
the predetermined potential is a potential supplied from a line that is, only at one end thereof, electrically connected to another line in the apparatus.

7. The solid-state imaging apparatus of claim 1 further comprising:
correction pixels which are read in a similar manner as the pixel cells; and
correction pixel reading units provided in correspondence with the correction pixels, each correction pixel reading unit reading an output from a corresponding correction pixel when the reading unit reads the outputs from the unit column circuits.

8. The solid-state imaging apparatus of claim 1,
wherein each switch enables and disables the electrical connection between the vertical common signal line and the unit column circuit in a vertical blanking period.
